(19) United States
(12) Patent Application Publication
(10) Pub. No.: US 2013/0321481 A1
(43) Pub. Date: Dec. 5, 2013

(54) SELF-LUMINESCENT DISPLAY APPARATUS, ADAPTIVE DISPLAY CONTROL METHOD AND ADAPTIVE ADJUSTING CIRCUIT

(71) Applicant: INDUSTRIAL TECHNOLOGY RESEARCH INSTIT, Hsinchu (TW)

(72) Inventors: Yi-Lun Wen, Xinwu Township (TW); Jing-Shan Liang, Zhubei City (TW)

(73) Assignee: INDUSTRIAL TECHNOLOGY RESEARCH INSTITUTE, Hsinchu (TW)

(21) Appl. No.: 13/666,379

(22) Filed: Nov. 1, 2012

(30) Foreign Application Priority Data
Jun. 4, 2012 (TW) 101120001

(51) Int. Cl. G09G 3/30; G09G 5/10; G06F 3/038

(52) U.S. Cl. 345/690; 345/204; 345/76

(57) ABSTRACT

A self-luminescent display apparatus is provided. The self-luminescent display apparatus includes a self-luminescent panel, a display controller and an adaptive adjusting unit. The self-luminescent panel comprises self-luminescent elements and an allowed active region. When the allowed active region is configured to a first range, the display controller drives the self-luminescent elements in the first range to display an image frame. The adaptive adjusting unit configures the allowed active region to a second range according to a trigger condition, and scales the image frame to correspond to the second range. The adaptive adjusting unit controls the display controller to drive the self-luminescent elements in the second range to display an adjusted image frame, and controls the self-luminescent elements outside the second range to turn off.

### CROSS-REFERENCE TO RELATED APPLICATION

This application claims the benefit of Taiwan application Serial No. 101120001, filed Jun. 4, 2012, the disclosure of which is incorporated by reference herein in its entirety.

### TECHNICAL FIELD

The disclosure relates to a self-luminescent display apparatus, an adaptive display control method and an adaptive adjusting circuit.

### BACKGROUND

An electronic device equipped with a display screen has become a prevalent and indispensable tool in the daily life along with advancements in technology. Electronic devices equipped with a display screen comprise handheld electronic devices, mobile communication devices, tablet computers and laptop computers. A heavy power-consuming component in these electronic devices is the display screen.

Most current display screens of the electronic devices only support two statuses—full-on and full-off. Such characteristic frequently cause power wasting in an unnoticed manner. For example, when making a telephone call using a physical keyboard, user attention is mostly focused at the accuracy of the numbers entered. From perspectives of resource efficiency, rather than altogether illuminating an entire screen including a part without any information that consumes unnecessary power as in the current design, the telephone call can nevertheless be smoothly completed by illuminating only the part of the display screen containing the telephone number.

### SUMMARY

The disclosure is directed to a self-luminescent display apparatus, an adaptive display control method and an adaptive adjusting circuit.

According to one embodiment, a self-luminescent display apparatus is provided. The self-luminescent display apparatus comprises a self-luminescent panel, a display controller and an adaptive adjusting unit. The self-luminescent panel comprises self-luminescent elements and an allowed active region. When the allowed active region is configured to a first range, the display controller drives the self-luminescent elements in the first range to display an image frame. The adaptive adjusting unit changes the allowed active region to a second range according to a trigger condition, and scales the image frame to correspond to the second range. The adaptive adjusting unit controls the display controller to drive the self-luminescent elements in the second range to display a adjusted image frame, and controls the self-luminescent elements outside the second range to turn off.

According to another embodiment, an adaptive display control method for a self-luminescent display apparatus having a self-luminescent panel is provided. The method comprises steps of: configuring an allowed active region to a first range, and driving a plurality of self-luminescent elements of the self-luminescent panel in the first range of the self-luminescent panel to display an image frame; changing the active region to a second range according to a trigger condition, and scaling the image frame to correspond to the second range; and driving self-luminescent elements in the second range of the self-luminescent panel to display a adjusted image frame, and controlling the self-luminescent elements outside the second range to turn off.

According to another embodiment, an adaptive adjusting circuit is provided. The adaptive adjusting circuit is for controlling a display controller to drive a self-luminescent panel. The self-luminescent panel comprises self-luminescent elements and an allowed active region. When the allowed active region is configured to a first range, the display controller drives the self-luminescent elements in the first range to display an image frame. The adaptive adjusting circuit comprises a trigger condition generating unit and an adaptive adjusting unit. The trigger condition generating unit generates a trigger condition. The adaptive adjusting unit, coupled to the display controller, configures to change the allowed active region to a second range according to the trigger condition, and scales the image frame to correspond to the second range. The adaptive adjusting unit further controls the display controller to control the self-luminescent elements in the second range to display a adjusted image frame, and controls the self-luminescent elements outside the second range to turn off.

### BRIEF DESCRIPTION OF THE DRAWINGS

FIG. 1A shows a schematic diagram of the allowed active range configured to a first range according to a first embodiment.

FIG. 1B shows a schematic diagram of the allowed active range configured to a second range according to a first embodiment.

FIG. 2 is a schematic diagram of a self-luminescent display apparatus according to the first embodiment.

FIG. 3 is a flowchart of an adaptive display control method according to the first embodiment.

FIG. 4 is a schematic diagram of a first-type adaptive adjusting unit.

FIG. 5 is a schematic diagram of a second-type adaptive adjusting unit.

FIG. 6 is a schematic diagram of a third-type adaptive adjusting unit.

FIG. 7 is a schematic diagram of a fourth-type adaptive adjusting unit.

FIG. 8 is a schematic diagram of a self-luminescent display apparatus according to a second embodiment.

FIG. 9 is a schematic diagram of a self-luminescent display apparatus according to a third embodiment.

FIG. 10 is a schematic diagram of a self-luminescent display apparatus according to a fourth embodiment.

FIG. 11 is a schematic diagram of a self-luminescent display apparatus according to a fifth embodiment.

FIG. 12 is a schematic diagram of an image frame according to the third embodiment.

FIG. 13A is a schematic diagram of self-luminescent elements in a first range and in a second range.

FIG. 13B is a schematic diagram of self-luminescent elements in a first range and in a second range.

FIG. 14 is a schematic diagram of different expected operable periods.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

In a conventional display screen, an allowed active region is fixedly configured to a size of the display screen. For example, after powering on a 50-inch display screen, the allowed active region for displaying an image frame is fixed to 50 inches. The size of the allowed active region may be regarded the same as a displayed image size after loading an operating system. In the embodiments below, the allowed active region is adaptively adjusted according to a trigger condition, and self-luminescent elements outside the allowed active region are correspondingly turned off to further reduce power consumption of the self-luminescent elements.

### First Embodiment

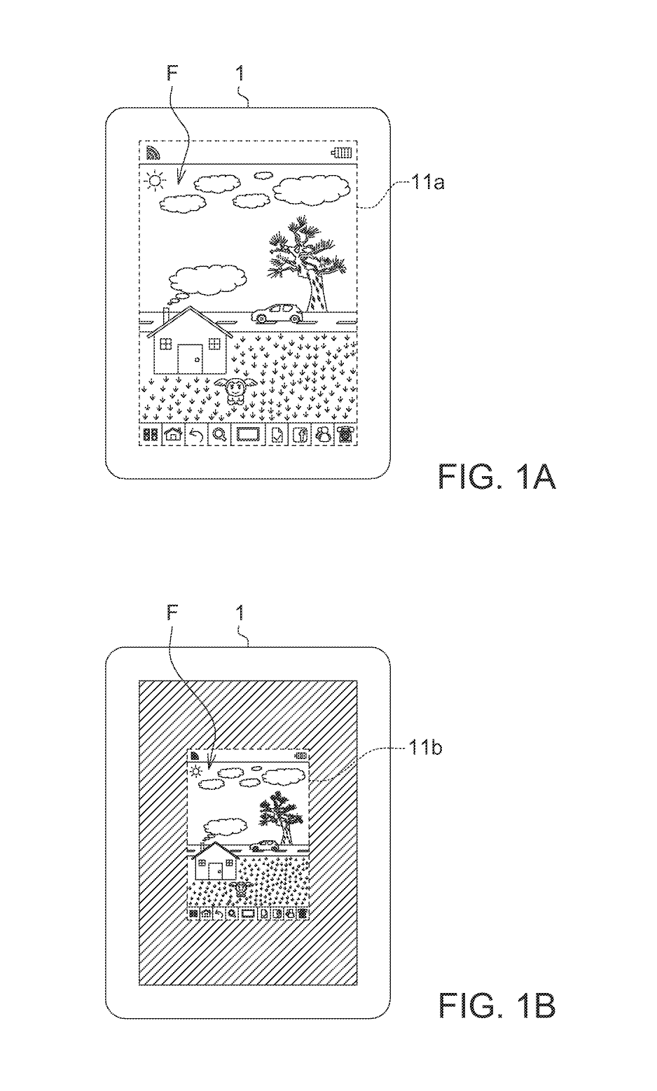

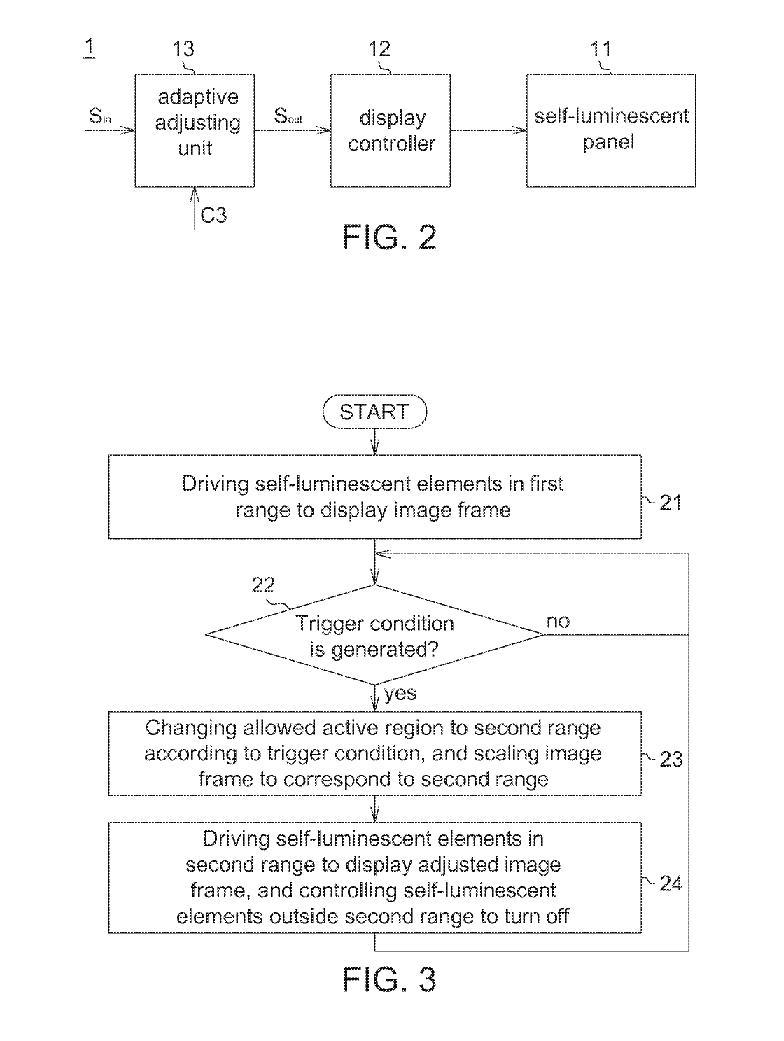

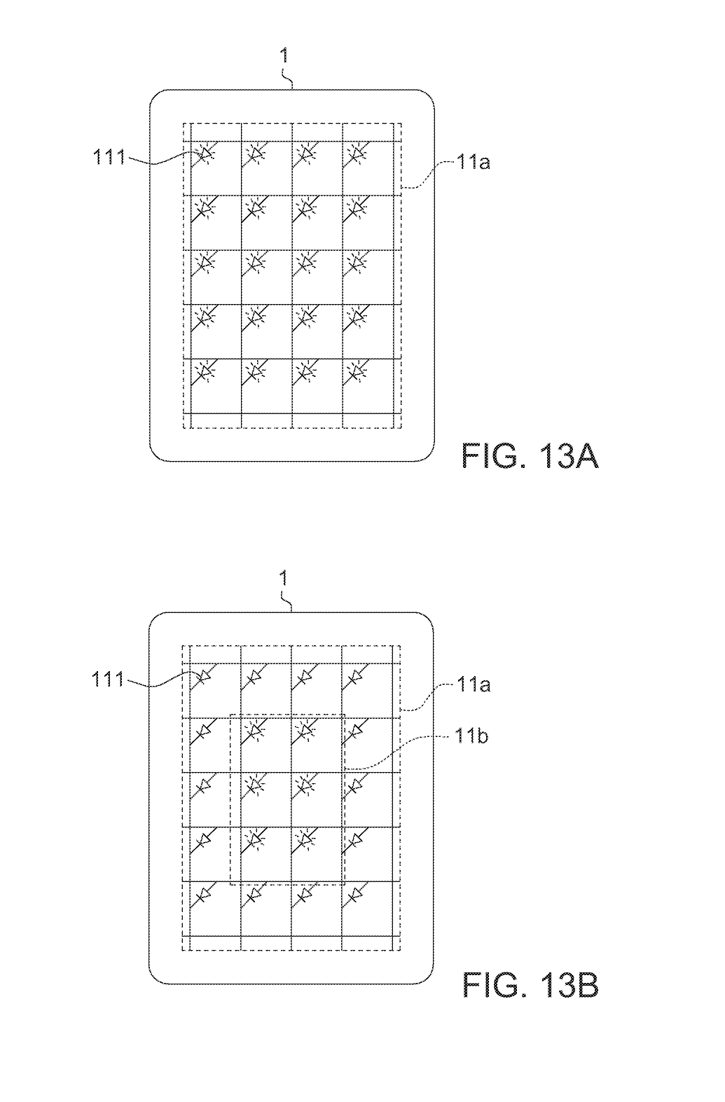

FIG. 1A shows a schematic diagram of the allowed active range configured to a first range according to a first embodiment. FIG. 1B shows a schematic diagram of the allowed active range configured to a second range according to a first embodiment. FIG. 2 shows a schematic diagram of a self-luminescent display apparatus according to the first embodiment. FIG. 3 shows a flowchart of an adaptive display control method according to the first embodiment. FIG. 13A shows a schematic diagram of illumination of self-luminescent elements in the first ranges. FIG. 13B shows a schematic diagram of illumination of self-luminescent elements in the first ranges. Referring to FIG. 1, a self-luminescent display apparatus 1 comprises a self-luminescent panel 11, a display controller 12 and an adaptive adjusting unit 13. For example, the self-luminescent display apparatus 1 is a handheld electronic device, a mobile communication device, a tablet computer or a laptop computer. For example, the adaptive adjusting unit 13 is implemented by hardware, software or integration. When a trigger condition C3 is generated, the adaptive adjusting unit 13 generates a display control signal Sₒᵤₜ according to a video signal Sᵢₙ and the trigger condition C3. The display controller 12 drives the self-luminescent panel 11 according to the display control signal Sₒᵤₜ. The self-luminescent panel 11 comprises multiple self-luminescent elements, which are organic light-emitting diodes (OLED) or polymer light-emitting diodes (PLED), for example. The self-luminescent panel 11 further comprises an allowed active region. A size of the allowed active region can be adjusted by the adaptive adjusting unit 13. The display controller 12 further comprises a microcontroller and a luminescent element driving circuit. The display controller 12 is coupled to the self-luminescent panel 11, and the adaptive adjusting unit 13 is coupled to the display controller 12. The adaptive display control method, applicable to the self-luminescent display apparatus 1, comprises the following steps.

Referring to FIG. 3, in Step 21, when the allowed active range is configured to a first range 11a, the display controller 12 drives self-luminescent elements 111 in the first range 11a to display an image frame F. In Step 22, the adaptive adjusting unit 13 determines whether the trigger condition C3 is generated. When the trigger condition C3 is not generated, a current display approach is maintained and whether the trigger condition C3 is generated is continuously monitored. Conversely, when the trigger condition

C3 is generated, Step 23 is performed. In Step 23, the adaptive adjusting unit 13 changes the allowed active region to a second range 11b according to the trigger condition C3, and scales the image frame to correspond to the second range 11b. In Step 24, the adaptive adjusting unit 13 controls the display controller 12 to drive the self-luminescent elements 111 in the second range 11b to display the adjusted image frame F, and controls the self-luminescent elements 111 outside the second range 11b to turn off.

It should be noted that, Step 22 is repeatedly iterated after performing Step 24 to determine whether a new trigger condition is generated. When a new trigger condition is generated, the current second range 11b is regarded as a next first range. In the subsequent Step 23, the adaptive adjusting unit 13 configures the allowed active region to the new second range according to the new trigger condition, and scales the image frame to correspond to the new second range.

The second range 11b is depicted at a center of the self-luminescent panel 11 as an example for illustrative purposes rather than limiting the embodiment therein. In an alternative embodiment, the position of the second range 11b may also be adjusted to outside the center of the self-luminescent panel 11. For example, the position of the second range 11b may be at an upper left corner, a lower left corner, an upper right corner, a lower right corner or any position of the self-luminescent panel 11.

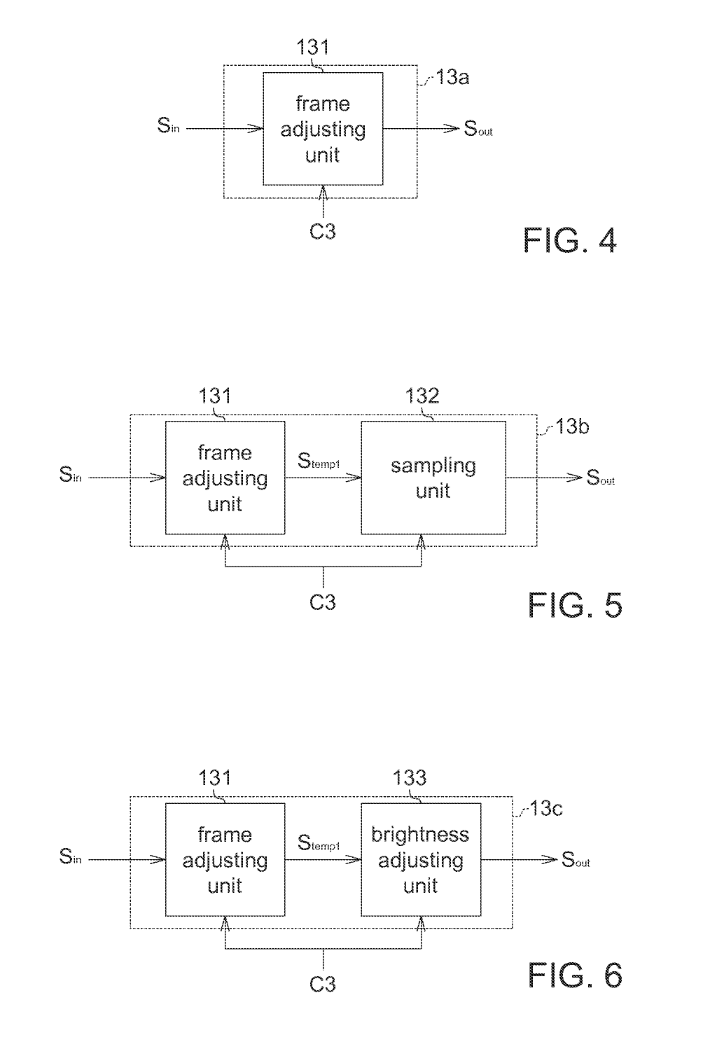

The adaptive adjusting unit 13 may be implemented in various forms, with a few examples to be described below. FIG. 4 shows a schematic diagram of a first-type adaptive adjusting unit. Referring to FIGS. 1, 2 and 4, a frame adjusting unit 131 adjusts the video signal Sᵢₙ according to the trigger condition C3 to generate the display control signal Sₒᵤₜ for controlling the display controller 12. The display controller 12 configures the allowed active region to the second range 11b according to the display control signal Sₒᵤₜ, and drives the self-luminescent panel 11 to display the adjusted image frame F in the second range 11b. For example, assume that the first range 11a is 50 inches, and the second range 11b is 30 inches. A portion of subtracting the second range 11b from the first range 11a is considered as a non-active region. That is, the self-luminescent elements 111 in the non-active region are turned off. Since the self-luminescent elements 111 outside the second range 11b are turned off, power consumption is saved to increase an operable period of the self-luminescent display apparatus.

FIG. 5 shows a schematic diagram of a second-type adaptive adjusting unit. Referring to FIGS. 1, 2 and 5, the second-type adaptive adjusting unit 13b comprises a frame adjusting unit 131 and a sampling unit 132. The frame adjusting unit 131 scales the frame size of the video signal Siₙ according to the trigger condition C3 to generate a adjusted video signal Sₜₑₘₚ₁. The sampling unit 132 samples the adjusted video signal Sₜₑₘₚ₁ according to the trigger condition C3 to generate the display control signal Sₒᵤₜ for controlling the display controller 12. The sampling unit 132 samples N pixels from every M pixels of the adjusted video signal Sₜₑₘₚ₁ for output, where M and N are positive integers, and N is smaller than or equal to M. For example, the sampling unit 132 samples one pixel from every four pixels of the adjusted video signal Sₜₑₘₚ₁ for output. Thus, the second-type adaptive adjusting unit 13b utilizes less self-luminescent elements than the firs-type adaptive adjusting unit 13a, so as to further save power consumption and to further increase an operable period of the self-luminescent display apparatus.

FIG. 6 shows a schematic diagram of a third-type adaptive adjusting unit. Referring to FIGS. 1, 2 and 6, a third-type adaptive adjusting unit 13c comprises a frame adjusting unit 131 and a brightness adjusting unit 133. The frame adjusting unit 131 scales the frame of the video signal Sᵢₙ according to the trigger condition C3 to generate an adjusted video signal Sₜₑₘₚ₁. The brightness adjusting unit 133 adjusts illumination brightness of the self-luminescent elements 111 in the second range 11b to generate the display control signal Sₒᵤₜ for controlling the display controller 12. For example, the brightness adjusting unit 133 proportionally reduces the illumination brightness corresponding to the self-luminescent elements in the second range 11b to one-half of the original brightness. Thus, compared to the first-type adaptive adjusting unit 13a, the third-type adaptive adjusting unit 13c further saves power consumption and further increases an operable period of the self-luminescent display apparatus.

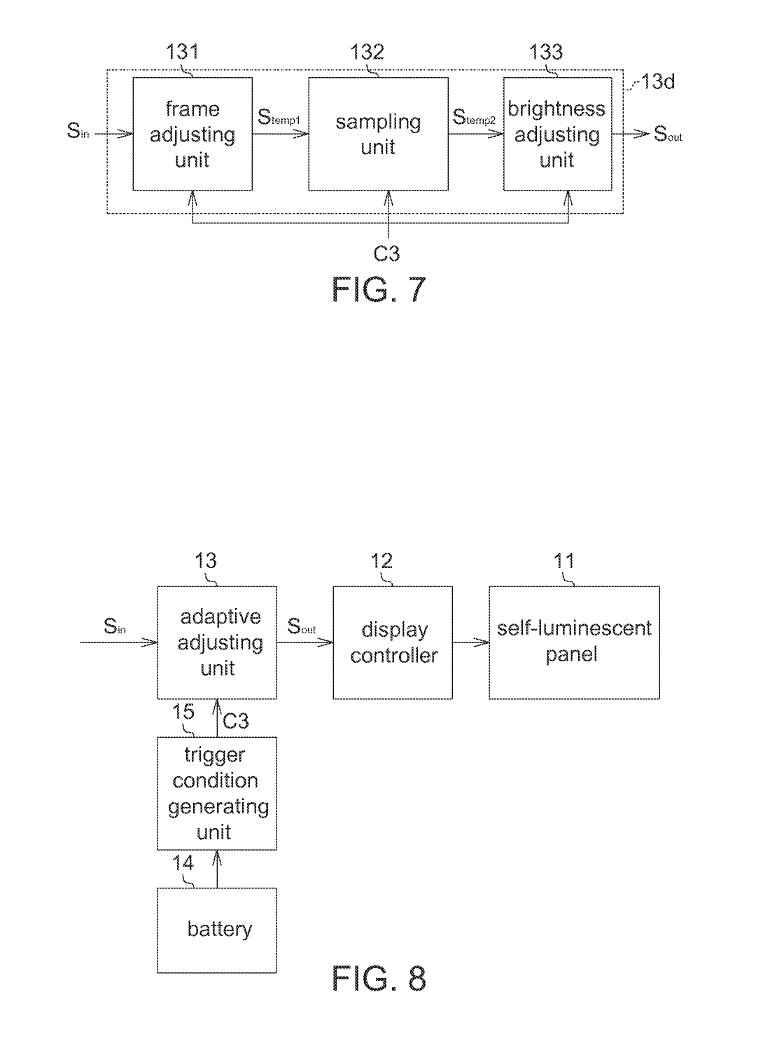

FIG. 7 shows a schematic diagram of a fourth-type adaptive adjusting unit. Referring to FIGS. 1, 2 and 7, a fourth-type adaptive adjusting unit 13d comprises a frame adjusting unit 131, a sampling unit 132 and a brightness adjusting unit 133. The frame adjusting unit 131 scales the image of the video signal Sᵢₙ according to the trigger condition C3 to generate the adjusted video signal Sₜₑₘₚ₁. The sampling unit 132 samples the adjusted video signal Sₜₑₘₚ₁ according to the trigger condition C3 to generate a sampled signal Sₜₑₘₚ₂. According to the trigger condition C3 and the sampled signal Sₜₑₘₚ₂, the brightness adjusting unit 133 adjusts illumination brightness of the self-luminescent elements 111 in the second range 11b to generate the display control signal Sₒᵤₜ for controlling the display controller 12. Since the fourth-type adaptive adjusting unit comprises functions of the first-type adaptive adjusting unit to the third-type adaptive adjusting unit, the fourth-type adaptive adjusting unit is capable of further saving power consumption and further increasing an operable period of the self-luminescent display apparatus.

### Second Embodiment

FIG. 8 shows a schematic diagram of a self-luminescent display apparatus according to a second embodiment. In addition to the self-luminescent panel 11, the display controller 12 and the adaptive adjusting unit 13, the self-luminescent display apparatus of the second embodiment further comprises a battery 14 and a trigger condition generating unit 15. The trigger condition generating unit 15 detects a remaining power of the battery 14 to generate a trigger condition C3. For example, when the remaining power of the battery 14 is lower than a trigger threshold, the trigger condition generating unit 15 generates the trigger condition for the adaptive adjusting unit 13. Thus, when the remaining power of the battery 14 is lower than a trigger threshold, the adaptive adjusting unit 13 drives the self-luminescent panel 11 to adjust the first range 11a to the second range 11b according to the trigger condition C3.

In an alternative embodiment, multiple trigger conditions may also be utilized. When the remaining power of the battery 14 reaches different trigger thresholds, the adaptive adjusting unit 13 correspondingly adjusts the size of the allowed active region.

### Third Embodiment

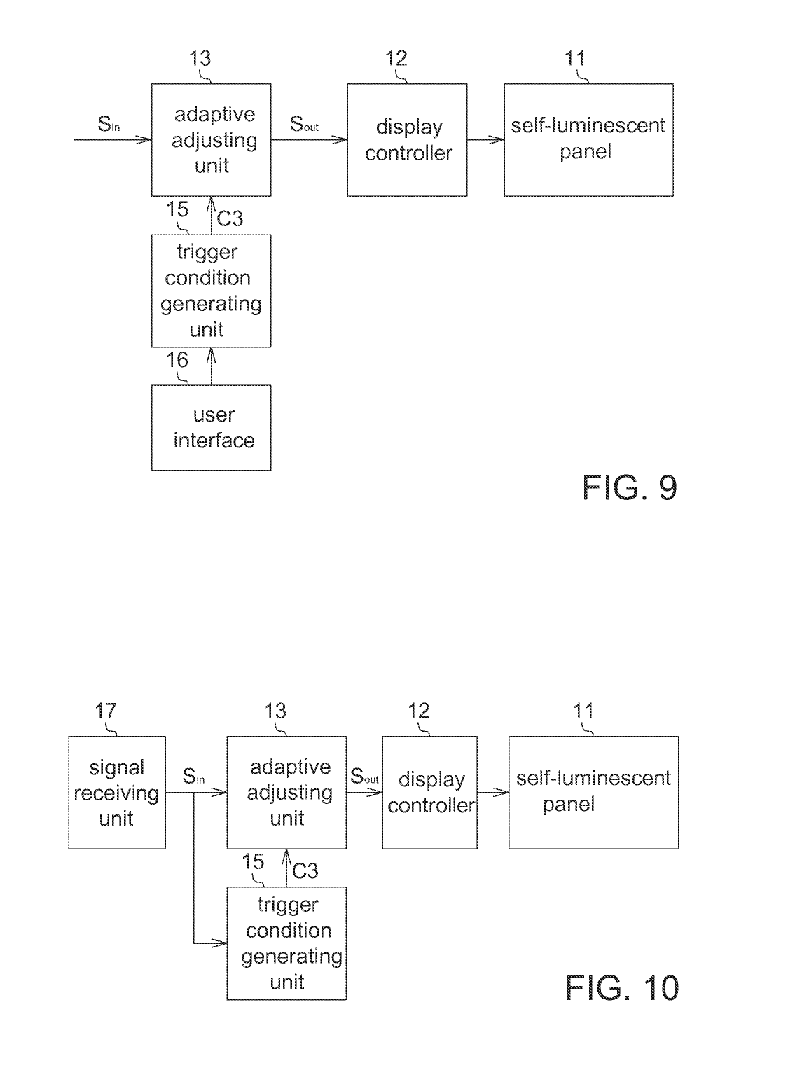

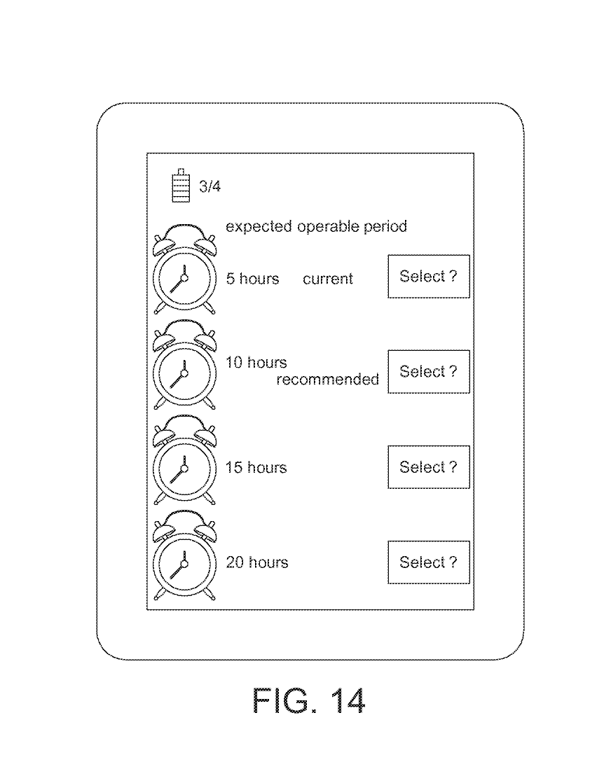

FIG. 9 shows a schematic diagram of a self-luminescent display apparatus according to a third embodiment. FIG. 12 shows a schematic diagram of an image frame according to the third embodiment. FIG. 14 shows a schematic diagram of different expected operable periods. Referring to FIGS. 1, 9, 12, and 14, in addition to the self-luminescent panel 11, the display controller 12 and the adaptive adjusting unit 13, the self-luminescent display apparatus of the third embodiment further comprises a trigger condition generating unit 15 and a user interface 16. The user interface 16 allows a user to enter an external command, according to which the trigger condition generating unit 15 generates the trigger condition C3. In other words, a user can manually adjust the first range 11a to the second range 11b via the user interface 16. For example, an approach for receiving the above external command may be setting a parameter, clicking and dragging through touch control or selecting a mode (from a menu). The parameter setting can be further stored as a personalized mode for enhancing convenience of use.

For example, assume that the user-entered external command is a user-expected operable period, which is a period of time that the user expects to be able to normally operate the self-luminescent display apparatus. Referring to FIG. 14, the self-luminescent display apparatus further displays different expected operable periods for a user to select from. To maintain a current condition, the allowed active region is continuously configured as the first region 11a, and the self-luminescent display panel can operate for five more hours. Supposing the user needs the self-luminescent display apparatus to operate for ten more hours, the user may select the option for an expected operable period of ten hours. At this point, the allowed active region is configured from the first range 11a to the second range 11b. The user may select the option for an expected operable period of fifteen hours if the user requires an even longer operable period. At this point, the allowed active region is configured from the first range 11a to the second range 11c. Alternatively, the user may directly select the option for an expected operable period of twenty hours. At this point, the allowed active region is configured from the first range 11a to the second range 11d.

In the third embodiment, the configuration of the allowed active region is modified through the external command. In an alternatively embodiment, the configuration of the allowed active region may be dynamically modified by detecting a remaining power of a battery. For example, a current condition is maintained when a considerable amount of remaining power is available, and the allowed active region is continuously maintained as the first range 11a. In contrast, when a rather limited amount of power remains, the allowed active region is configured to the second range 11b, the third range 11c or the fourth range 11d to increase the operable period of the self-luminescent display apparatus.

### Fourth Embodiment

FIG. 10 shows a schematic diagram of a self-luminescent display apparatus according to a fourth embodiment. Referring to FIGS. 1 and 10, in addition to the self-luminescent panel 11, the display controller 12 and the adaptive adjusting unit 13, the self-luminescent display apparatus of the fourth embodiment further comprises a trigger condition generating unit 15 and a signal receiving unit 17. The signal receiving unit 17 receives the video signal Sᵢₙ. The trigger condition generating unit 15 determines whether an original resolution of the video signal Sᵢₙ is the same as a predetermined resolution of the self-luminescent panel 11. When the original resolution of the video signal Sᵢₙ differs from the predetermined resolution of the self-luminescent panel 11, the trigger condition C3 is generated according to the original resolution of the video signal Sᵢₙ. For example, assume the predetermined resolution of the luminescent panel 11 is 1920×1080 pixels, and the original resolution of the video signal Sᵢₙ is 1280×720 pixels. The trigger condition generating unit 15 generates the trigger condition C3 according to the original resolution of the video signal Sᵢₙ. According to the trigger condition C3, the adaptive adjusting unit 13 adjusts the allowed active region from the first range 11a of 1920×1080 pixels to the second range 11b of 1280×720 pixels. In other words, the self-luminescent display apparatus is capable of adaptively adjusting the first range 11a to the second range 11b according to the original resolution of the video signal Sᵢₙ.

Further, the adaptive adjusting unit 13 and the trigger condition generating unit 15 may be integrated into an adaptive adjusting circuit implemented by an integrated circuit.

### Fifth Embodiment

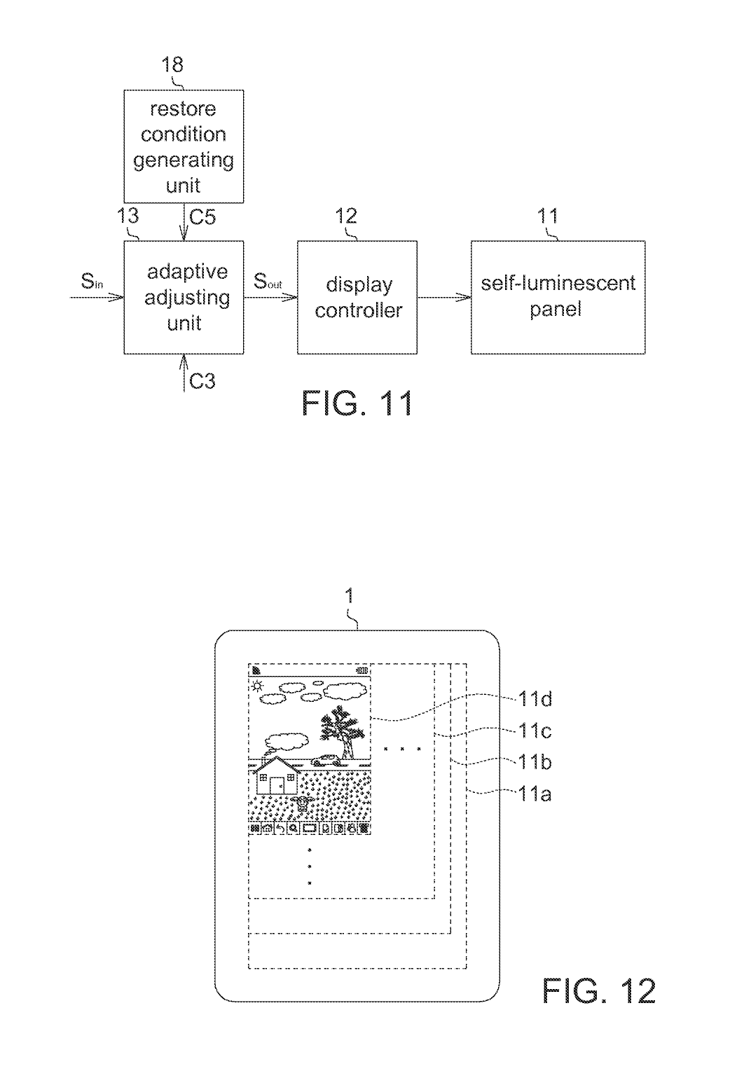

FIG. 11 shows a schematic diagram of a self-luminescent display apparatus according to a fifth embodiment. Referring to FIGS. 1 and 10, in addition to the self-luminescent panel 11, the display controller 12 and the adaptive adjusting unit 13, the self-luminescent display apparatus of the fifth embodiment further comprises a restore condition generating unit 18. The restore condition generating unit 18 determines whether an external power supply is received, and generates a restore condition C5 when the external power supply is received. The adaptive adjusting unit 13 configures the allowed active region from the second range 11b to the first range 11a according to the restore condition C5. For example, the restore condition generating unit 18 determines whether a power plug of the self-luminescent display apparatus is connected to a power socket to receive city electricity. When the power plug of the self-luminescent display apparatus is connected to the power socket, the self-luminescent display apparatus adaptively configures the allowed active region from the second range 11b to the first range 11a.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A self-luminescent display apparatus, comprising:
a self-luminescent panel, comprising a plurality of self-luminescent elements and an allowed active region;
a display controller, coupled to the self-luminescent panel, configured to drive the self-luminescent elements in a first range to display an image frame when the allowed active region is configured to the first range; and
an adaptive adjusting unit, coupled to the display controller, configured to change the allowed active region to a second range according to a trigger condition and to scale the image frame to correspond to the second range, configured to control the display controller to drive the self-luminescent elements in the second range to display an adjusted image frame, and configured to control the self-luminescent elements outside the second range to turn off.

2. The self-luminescent display apparatus according to claim 1, wherein
the adaptive adjusting unit comprises:
a frame adjusting unit, configured to adjust a video signal according to the trigger condition.

3. The self-luminescent display apparatus according to claim 2, wherein the adaptive adjusting unit further comprises:
a sampling unit, configured to sample the adjusted video signal according to the trigger condition.

4. The self-luminescent display apparatus according to claim 3, wherein the adaptive adjusting unit comprises:
a brightness adjusting unit, configured to adjust illumination brightness of the self-luminescent elements in the second range to generate a display control signal according to the trigger condition and the adjusted video signal; wherein the display control signal is for controlling the display controller.

5. The self-luminescent display apparatus according to claim 3, wherein the adaptive adjusting unit comprises:
a brightness adjusting unit, configured to adjust illumination brightness of the self-luminescent elements in the second range to generate a display control signal according to the trigger condition and the sampled video signal; wherein the display control signal is for controlling the display controller.

6. The self-luminescent display apparatus according to claim 1, further comprising:
a battery; and
a trigger condition generating unit, configured to detect a remaining power of the battery to generate the trigger condition.

7. The self-luminescent display apparatus according to claim 1, further comprising:
a user interface, configured to receive an external command;
a trigger condition generating unit, configured to generate the trigger condition according to the external command.

8. The self-luminescent display apparatus according to claim 1, further comprising:
a signal receiving unit, configured to receive a video signal; and
a trigger condition generating unit, configured to determine whether an original resolution of the video signal is same as a predetermined resolution of the self-luminescent panel, and generate the trigger condition when the original resolution of the video signal differs from the predetermined resolution of the self-luminescent panel.

9. The self-luminescent display apparatus according to claim 1, further comprising:
a restore condition generating unit, configured to determine whether an external power supply is received, and generate a restore condition when the external power supply is received;
wherein, the adaptive adjusting unit configures the allowed active region from the second range to the first range according to the restore condition.

10. The self-luminescent display apparatus according to claim 1, wherein a size of the allowed active region is same as an image range displayed after loading an operating system.

11. An adaptive display control method for a self-luminescent display apparatus having a self-luminescent panel, comprising:
configuring an allowed active region to a first range, and driving a plurality of self-luminescent elements of the self-luminescent panel in the first range to display an image frame;
changing the allowed active region to a second range according to a trigger condition and scaling the image frame to correspond to the second range; and
driving the self-luminescent elements in the second range to display a adjusted image frame, and controlling the self-luminescent elements outside the second range to turn off.

12. The method according to claim 11, further comprising:
adjusting a video signal according to the trigger condition.

13. The method according to claim 12, further comprising:
sampling the adjusted video signal according to the trigger condition.

14. The method according to claim 13, further comprising:
adjusting illumination brightness of the self-luminescent elements in the second range to generate a display control signal according to the trigger condition and the adjusted video signal; wherein the display control signal is for controlling a display controller.

15. The method according to claim 13, further comprising:
adjusting illumination brightness of the self-luminescent elements in the second range to generate a display control signal according to the trigger condition and the sampled video signal; wherein the display control signal is for controlling a display controller.

16. The method according to claim 11, further comprising:
detecting a remaining power of a battery to generate the trigger condition.

17. The method according to claim 11, further comprising:
receiving an external command via a user interface; and
generating the trigger condition according to the external command.

18. The method according to claim 11, further comprising:
receiving a video signal;
determining whether an original resolution of the video signal is same as a predetermined resolution of the self-luminescent panel; and
generating the trigger condition when the original resolution of the video signal differs from the predetermined resolution of the self-luminescent panel.

19. The method according to claim 11, further comprising:
whether an external power supply is received;
generating a restore condition when the external power supply is received; and
configuring the allowed active region from the second range to the first range according to the restore condition.

20. The method according to claim 11, wherein a size of the allowed active region is same as an image range displayed after loading an operating system.

21. An adaptive adjusting circuit, for controlling a display controller to drive a self-luminescent panel, the self-luminescent panel comprising a plurality of self-luminescent elements and an allowed active region, the display controller configured to drive the self-luminescent elements in a first range to display an image frame when the allowed active region is configured to a first range; the adaptive adjusting circuit comprising:
a trigger condition generating unit, configured to generate a trigger condition; and
an adaptive adjusting unit, coupled to the display controller, configured to change the allowed active region to a second range according to the trigger condition and to scale the image frame to correspond to the second range, configured to control the display controller to drive the self-luminescent elements in the second range to display an adjusted image frame, and configured to control the self-luminescent elements outside the second range to turn off.

22. The adaptive adjusting circuit according to claim 21, wherein the adaptive adjusting unit comprises:
a frame adjusting unit, configured to adjust a video signal according to the trigger condition.

23. The adaptive adjusting circuit according to claim 22, wherein the adaptive adjusting unit comprises:
a sampling unit, configured to sample the adjusted video signal according to the trigger condition.

24. The adaptive adjusting circuit according to claim 23, wherein the adaptive adjusting unit comprises:
a brightness adjusting unit, configured to adjust illumination brightness of the self-luminescent elements in the second range to generate a display control signal according to the trigger condition and the adjusted video signal; wherein the display control signal is for controlling the display controller.

25. The adaptive adjusting circuit according to claim 23, wherein the adaptive adjusting unit comprises:
a brightness adjusting unit, configured to adjust illumination brightness of the self-luminescent elements in the second range to generate a display control signal according to the trigger condition and the sampled video signal; wherein the display control signal is for controlling the display controller.
